(19) United States
(12) Patent Application Publication
(10) Pub. No.: US 2002/0016155 A1
(43) Pub. Date: Feb. 7, 2002

(54) Mobile telephone and method for the parametrization of the telephone

(76) Inventor: Philippe Charbonnier, rue de Bellevue (FR)

Correspondence Address: NILLES & NILLES, SC, FIRSTAR CENTER, SUITE 2000, 777 EAST WISCONSIN AVENUE, MILWAUKEE, WI, 53202, US

(21) Appl. No.: 09/859,220

(22) Filed: May 16, 2001

(30) Foreign Application Priority Data
May 17, 2000 (FR) 00 06482

(51) Int. Cl. H04B 1/38

(52) U.S. Cl. 455/90; 455/425; 455/550

(57) ABSTRACT

An improved mobile telephone (1) is made. It is improved in the sense that it assesses the SAR, namely the power thermally absorbed by a material representing biological tissues placed against the telephone in conditions of use, and it parametrize its operation according to this rate. Thus, a solution is proposed guaranteeing the user a use of the telephone that is without risk for his health.

### BACKGROUND OF THE INVENTION

1. Field of the Invention

An object of the invention is an improved mobile telephone and a method for the parametrization of this telephone. The field of application is mobile telephony in both speech communications and data communications. The aim of the invention is to improve the mobile telephone to ensure that the user will be able to use the telephone without any risk to his health.

2. Description of the Prior Art

Mobile telephones emit radiation during communication. Users are spending an increasing amount of time with mobile telephone held to their ear, and research organizations have been assessing the possible effects of this on health. The effect identified to date is that the regions of the brain close to the instrument get heated. This effect is characterized by the power thermally absorbed by a material representing the biological tissues placed against the instrument in conditions of use. This power defines the specific absorption rate (SAR). To measure this quantity SAR, the average is taken of the power value over a period of six minutes as laid down by the International Commission of Non-Ionizing Radio Protection (ITNIRP). This organization recommends a maximum SAR rate, not to be exceeded, of two watts per kilo if only the head is exposed to radiation, and a maximum SAR rate, not to be exceeded, of 0.08 watts per kilo if the entire body is exposed. The six minutes' duration is related to the circulation of blood in the brain which acts like the fluid of a heat sink.

At present, mobile telephones comply with the ICNIRP rates without great difficulty or excess cost. Indeed, the power emitted is presently a maximum of 2 watts every eighth of the time (in GSM TDMA mode). This produces an absorption that is almost acceptable at the outset. Mobile telephone manufacturers have been making a number of improvements through various devices, for example by promoting a field of emission of the antenna in the direction opposite the brain, or by moving the antenna slightly away from the brain.

It is also possible to envisage a U-shaped metal transmitter producing radiation in a magnetic field in such a way that the head region is avoided.

Today, mobile telephones comply with the fixed SAR rates but, in the near future, mobile telephones will be able to carry out data communications, for example GPRS communications, simultaneously with voice communications. In this case, since the communication may be permanent, the reduction to oneeighth will no longer occur. It is thus possible to imagine a computer connected to a mobile telephone that he uses as a modem. The user consults the Internet and, at the same time, receives a phone call. Two channels, with a bit rate far greater than the one used today will be used. As the case may be, it could be possible to accept power values greater than the two watts in use today. Or again, the use of a microphone and of a earpiece in an RF link with the mobile telephone may lead to dangerous uses, even if the mobile telephone itself is at a distance. It is also possible to envisage a situation where the rules, in future, will lay down more stringent values that are economically untenable with present-day techniques. It may then be feared that present-day solutions will no longer be sufficient.

According to the invention, this problem is resolved by making a mobile telephone that evaluates the SAR rate of its user. Preferably, this approach enables the mobile telephone to control its use (or that of its accessories). For example, the mobile telephone limits its calls/or its transmission when a threshold has been reached. The measurement will be preferably cumulative and performed on a sliding duration in time (for example a six-minute duration).

The emission power of the mobile telephone is normally remote-controlled by the network to optimize all the on-going calls of the cell in which the telephone is located. Since the emission levels of the telephone are calibrated and since the network dictates which level it should use, a mobile telephone permanently knows the power at which it is emitting. By calibration in working conditions, the manufacturer may correlate the power emitted with the power absorbed by the body or the brain, the brain being the part of the body most sensitive to radiation. He can thus set limits of emitted power that comply with the SAR limits. The telephone can thus compare its emission power (averaged over six minutes in a preferred embodiment) with said limits in taking account, in the preferred embodiment, of the proximity of the brain. He can also compare its emission power with the fixed limits in taking account of the frequency band considered. The result of this comparison determines the steps taken on the working at the telephone.

To date, the only known biological effect of radiotelephony waves on human beings is the heating characterized by the notion of the SAR. It is possible that other effects will be identified one day, related for example to the electrical field component rather than the power. The manufacturers will always be able to make a correlation with the emitted power, and it is possible that its cumulative total over a certain period of time will be equally decisive. The invention would therefore also be applicable with appropriate thresholds.

### SUMMARY OF THE INVENTION

The invention therefore relates to a mobile telephone comprising means to know the proximity of the brain of a mobile telephone user and means to assess a dose of absorption of radiation that the mobile telephone produces in the user's biological tissues, under conditions of use, the assessment of the radiation dose taking account of the proximity or non-proximity of the user's brain.

The invention also relates to a method for the parameterization of a mobile telephone, wherein:

an emitted energy is measured,

the emitted energy measurement is processed to make it representative of a dose received by the user,

this processed measurement is compared with a threshold,

a limitation of activity of the telephone is determined as a function of the result of the comparison.

### BRIEF DESCRIPTION OF THE DRAWINGS

The invention will be understood more clearly from the following description and the appended drawings. These drawings are given purely by way of an indication and in no way restrict the scope of the invention. Of these figures:

FIG. 1 shows a mobile telephone according to the invention;

FIG. 2 shows a preferred algorithm to manage the power absorbed by the user during a sliding six-minute period,

FIG. 3 shows a preferred algorithm to compute the power absorbed during a three-second period.

### MORE DETAILED DESCRIPTION

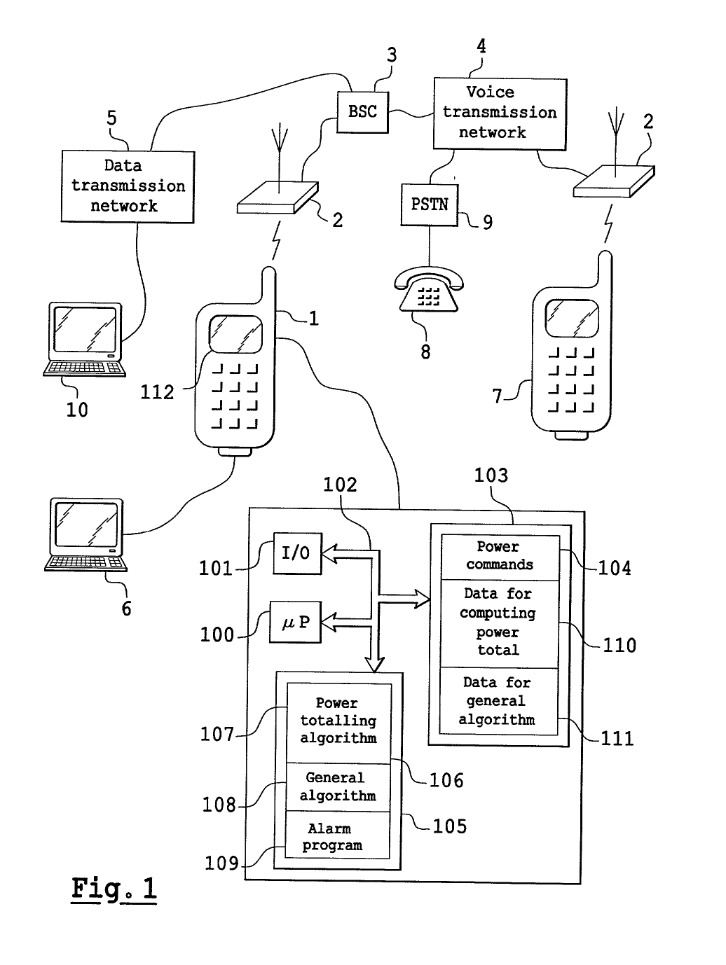

FIG. 1 shows a mobile telephone 1 capable for example of setting up and managing a voice communication and a data communication simultaneously. The mobile telephone 1 sends radioelectric waves to a base station 2. The base stations, which are of the base station 2 type with which the mobile telephone 1 communicates, are controlled by a base station controller 3, known as BSC. Depending on the nature of the call, the BSC controller 3 sends information to a network 4 or a network 5. The network 4 for example deals with voice communications in a circuit mode and the network 5 for example manages data communications in a packet mode.

The user for example has connected his mobile telephone 1 to a computer 6 and is on the Internet. Programs consulted by the user on the Internet are hosted, for example, in a server computer 10 connected to the network 5. While the user is on the Internet, a telephone call reaches him. The telephone call may come either from a mobile telephone 7 or from a fixed telephone 8. The fixed telephone 8 is connected to a public switched telephone network 9 which is itself connected to the network 4. The radioelectric link between the network 4 and the mobile telephone 7 is set up by a base station 2.

The mobile telephone 1 for example is of the two-watt GSM type. It can be remote-controlled at power values of 20 milliwatts to two watts in steps of two decibels. A power control received by the telephone 1 at a periodicity of 60 milliseconds is conveyed by a channel known as SACCH and is processed by software programs of a general microprocessor 100 of the telephone 1. The mobile telephone can therefore know and memorize the values of power emitted by it, in the course of time, in a memory compartment.

A transceiver 101 of the mobile telephone 1 is connected to the microprocessor 100 by means of a bus 102. When the network 4 or 5 sends the telephone 1 the value of the power at which it has to send, this information is received by the transceiver 101 which, according to the invention, transmits it to a data memory 103 by means of the bus 102 . A piece of power control information is stored in a memory space 104 of the data memory 103.

According to the invention, a program memory 105 of the mobile telephone 1 contains a program 106 managing the SAR rate of the telephone 1. More generally, according to the invention, the program 106 manages the instantaneous or mean power sent out by the telephone 1. The program 106 especially has a first sub-program 107 that contains a preferred algorithm used to compute the power absorbed during a three-second period. A second subprogram 108 is set up in the program 106 and contains a preferred algorithm to manage the power absorbed by the user over a six-minute period. And a third alarm sub-program 109, contained in the program 106, sets up appropriate action if an alarm threshold S be crossed.

Data for the computation of the cumulative total power over a three-second period are stored in a memory space 110 of the data memory 103 and data for the algorithm for managing the absorbed power are stored in the memory space 1 1 1 of this memory 103.

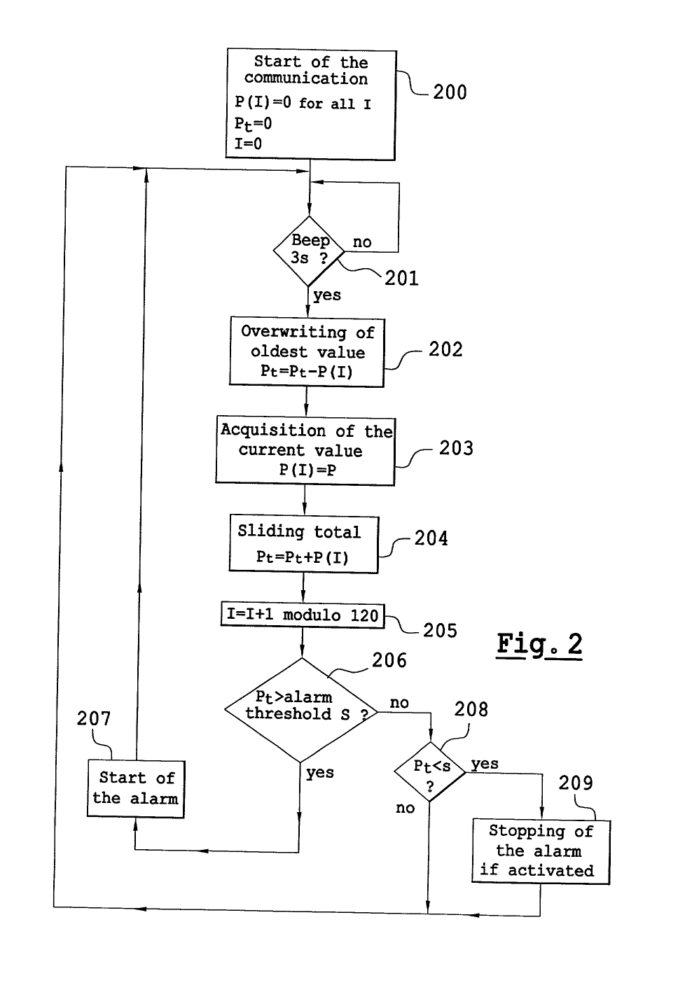

The setting up of at least one communication for the telephone activates the program 106. FIG. 2 shows a preferred algorithm to manage the power absorbed by the user during a sliding six-minute period.

According to this algorithm, when a first call is made, an initial stage is defined during a step 200: a value of absorbed power indexed by an index I, P(I), is zero whatever the value of I. A total power value Pt is zero. The index I is initially at zero. Then, during a test 201, it is ascertained whether a start or a three-second beep has been activated, namely if three seconds have elapsed. If three seconds have not elapsed, no action is taken. There is a wait for three seconds to elapse. If three seconds have elapsed, there is a passage to a step 202 during which an old value P(I-6) is deducted from the power Pt. The value P(I-6) is the power value six minutes previously. It is zero when the algorithm is started, the step 200 being taken into account.

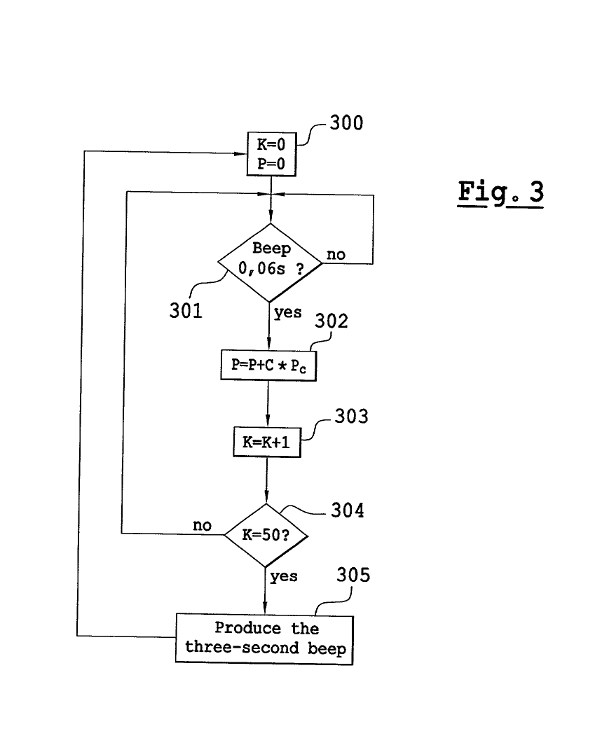

Then, during a step 203, the power P(I) assumes a current power value. The current power value P is preferably determined by means of an algorithm shown in FIG. 3 and set up during the three seconds of the test 201.

Indeed, power commands arrive every 60 milliseconds from the base station 2. It is desired to obtain a sliding mean on six seconds, i.e. 360 seconds. It is then possible, according to a first variant, to memories the 6,000 power values used during the last 360 seconds in order to obtain a sliding average. In this variant, a new power value would take the place of the oldest power value in the memory. However, such a step is unnecessarily precise and takes up memory space. It is more advantageous then to adopt a rougher granularity, for example, by 50 samples representing three seconds of elapsed time. This granularity is set up by means of the algorithm of FIG. 3. This algorithm gives a power value P for a period.

The algorithm of FIG. 3 computes the cumulative total of the value of power P of a period over a period of three seconds. In this computation, and during a step 300, the period power P and an incrementation index K are respectively initialized at zero.

With power commands arriving every 60 milliseconds, a test 301 is implemented. This test 301 determines whether 60 milliseconds have elapsed. Should the test 301 be positive, the period power P measured is equal to a previously computed period power P incremented by a current power value Pc. In one example, the current value Pc is the value of the power that has just been received from the base station as a power command and is memorized in the data memory 103, preferably multiplied by a coefficient of use C. The coefficient of use C equal to 1 if the instrument is close to the ear. It is negligible compared to 1 if the machine is far from the ear. The current power value Pc can therefore be acquired in other ways, for example by measuring the current consumed by an output amplifier of the transceiver. The preferred approach, however, has the advantage of requiring no additional hardware construction for the mobile telephone.

Then, during a step 303, K is incremented by one. Then, a test 304 is conducted to ascertain whether or not K is equal to 50. Should K not be equal to 50, the steps of the algorithm are recommenced from this test 301. If not, during a step 305, a three-second beep signal is produced. This signal comes into play in the algorithm of FIG. 2 at the same time as the value P(I) is available at the end of the period 1, herein equal to three seconds.

A following step 204 of FIG. 2 is then used to compute the total cumulative power Pt. The total cumulative power Pt is equal to the last value of the power Pt incremented by the value of the power P(I).

Then, during a following step 205, the index I module 120 is incremented by one. The step 205 makes the program run circularly on 120 positions. Then a test 206 is performed.

During this test 206, a check is made to find out if the total cumulative energy during six minutes is greater than an alarm threshold S.

If the threshold S has been reached or crossed, in a preferred example, an alarm is activated during a step 207. During the step 207, the sub-program 109 is also activated. There is then a return to the step 201.

If the total power Pt accumulated during the last six minutes is not greater than the threshold S then, during a test 208, it is seen whether Pt is below a lower limit s. The limit s is below the threshold S. The limit s has no significance except when the SAR computed is supposed to be sensitive or even dangerous for the health of the user of the telephone 1. Indeed, the interval characterized by the threshold S and threshold s defines a danger zone for the user. Thus, if the threshold s has been crossed, the alarm will not be turned off unless the total power Pt is below the threshold s.

Should the test 208 be positive and should the alarm program be put into operation, the alarm is stopped during a step 209 and the system then passes again to the step 201.

Should the test 208 be negative, the algorithm is resumed from the step 201.

The algorithm is used to set up a sliding mean. The power Pt is a sliding total because the oldest value (P(I) before overwriting) is deducted from it and the most recent value (P(I) after overwriting) is added to it. The threshold test is done permanently and the SAR can be displayed on the screen 112 of the telephone 1. As an alternative, it may be simply specified whether the operation is in a state below or above the threshold S. The user can thus know the power that his head is supposed to be absorbing and can know if conditions favorable to his health are being met.

According to the invention, the mobile telephone 1 assesses an SAR as soon as at least one call has been set up and limits its operation when an alarm threshold S is reached. The threshold S may be defined by a regulating authority. The telephone 1 then totalizes the energy that it sends in taking account, in the preferred embodiment of the invention, of the proximity of the brain. Then it compares the energy emitted in a six-minute with the threshold S.

Indeed, there are many ways in which the mobile telephone 1 can find out if the brain is close to or distant from said telephone and especially from the antenna. It can know this directly for example by means of an acoustic, capacitive or infrared sensor located in the vicinity of the listening device and giving information on the distance between the user's head and this sensor.

The telephone 1 can also indirectly deduce the proximity of the user's head and therefore that of the user's brain. This method of indirect deduction may be based on several indications. For example, since the microphone of the telephone is close to the earpiece, it can be assumed that, if the voice signal received by the telephone is strong, it means that the user is close to the microphone and therefore close to the earpiece. If, on the contrary, the received voice signal is weak, or if it has reverberations, then it means that the user is distant from the telephone and that he is using the hands-free function of the telephone. Another indication that can be used for indirect deduction may be the fact that the hands-free option is being activated or not. This hands-free option may consist of the activation of a loudspeaker or a sensitive microphone or else of the connection of a hands-free headset kit consisting of a headphone with microphone and earpiece. In both cases of hands-free options, the antenna of the telephone is distant from the user's head. Should the hands-free option comprise a loudspeaker with a modifiable volume, it is also possible to look at the selected volume level: the higher the volume the greater the distance of the telephone from the user, and vice versa. Another indication may be obtained by looking at whether the keypad cover flap is open in a support position on the table. If this is the case, it can be deduced there from that the telephone is placed on the table and that, consequently, the antenna is at a distance from the user's head.

When determining the proximity of the user's brain, it is also important to know whether it is only a voice communication or data communication or whether it is a simultaneous data and voice communication. It can be seen that, in pure data communication, the power may be great (through the use of several TDMA slots as against only one slot used in voice communication) but that the user will have no reason to place the telephone against his head. On the contrary, in simultaneous data and voice communication, the telephone may be placed against the user's head and the power absorbed may be greater with the user being aware of it.

Yet other methods can be conceived in order to determine the proximity of the user's brain. These methods can be used to separately or, on the contrary, in combination so as to improve its reliability.

Furthermore, two methods to obtain an account of the energy absorbed can be envisaged. The first method totalizes the energy emitted over a sliding six-minute period when the instrument is near the brain. When a limit L1 is reached, it is considered that the borderline SAR has been reached for the brain and appropriate steps are taken. A second method totalizes the energy emitted over six minutes whether the instrument is near or far from the brain. When a limit L2 is reached, it is assumed that the borderline SAR for the entire body (which is another rate different from the rate for the head) has been reached, and appropriate steps are taken.

The appropriate steps and limits may be of different kinds. They may comprise, for example:

a warning to the user who stays in control of his fate. The warning may be for example a warning in the form of sound. The warning may also take the form of an intermittent broadcasting of speech and/or data transmissions for a specified period,

a refusal to let through an outgoing or incoming voice call so long as the accounted energy has not fallen below a bottom limit equal to example to half of the limit L1,

a refusal to let through a data transmission when a voice communication in progress is already at the limit,

a slowing down of data transmission, for example GPRS transmission, simultaneously with the voice communication if the SAR limit has been reached.

The telephone 1 by itself reduces its GPRS transmission bit rate. Indeed, in GPRS technology, which is a packet technology, it is quite natural for the sender (in this case the mobile phone) to have control over the instants of the sending of its successive packets. The telephone can thus space out its packets so as to dilute its emitted energy in time. It can also make arrangements with the network to reduce the number of TDMA windows used.

It is also be possible to envisage a simplified evaluation of the energy based on what is known as instantaneous power. This power known as instantaneous power will be a mean power on a short time scale, for example over one second or again on the scale of the TDMA frame.

The telephone 1 compares the instantaneous power that it emits with a threshold (in taking or not taking account of the proximity of the head). The telephone 1 modifies its operation on the basis of this comparison. This power threshold is chosen so that the statutory quantity (SAR) is definitely complied with when it is not known whether or not the instantaneous power will be maintained for a long time. In the invention, to take account of the case where it is maintained for six minutes, the power threshold is taken to be equal to 1/360 of the transmitted energy supposed to correspond to the statutory absorbed energy.

An implementation of this kind is simpler than the one described in the preferred embodiment of the invention. Indeed, this other implementation does not require the computation of a cumulative total. However, it generates alarms or transmission blocks more frequently because it does not allow for the strictest compliance with the regulations.

The mobile telephone 1 assesses the power or energy emitted: it is correlated with the SAR absorbed by humans through laboratory studies by the manufacturer and it is correlated with thresholds in the same way.

Whatever the embodiment chosen, the invention can be used not only to determine the electrical magnitudes needed to estimate the quantity of radiation received by the user but also to convert these electrical magnitudes into biological criteria related to natural human capacities. Indeed, the choice of the size of the sliding window takes account of the behavior of the head in absorption, especially that of the capacity of the blood to discharge the calories brought to the brain by the radiation emitted by the mobile telephone antenna. Furthermore, the correspondence between electrical magnitudes and biological criteria has been calibrated in the stage of designing the instrument. In the software of the instrument, this correspondence takes the form of the practical thresholds to be used.

What is claimed is:

1. A mobile telephone comprising means to know the proximity of a mobile telephone user's brain and means to assess a dose of radiation absorption that the mobile telephone might produce in the user's biological tissues, in conditions of use, the assessment of the radiation dose taking account of the proximity or non-proximity of the user's brain.

2. A telephone according to claim 1, wherein absorption dose is a specific absorption rate (SAR).

3. A telephone according to claim 1, comprising means to parametrize its operation as a function of the result of the assessment.

4. A telephone according to one of the claims 1 to 3, comprising means for the simultaneous execution of a voice communication and a data communication.

5. A telephone according to one of the claims 1 to 4, comprising means for the display, on a screen, of a specific absorption rate (SAR) or a crossing or non-crossing of a limit by this rate.

6. A method for the parameterization of a mobile telephone wherein:
an emitted energy is measured,
the emitted energy measurement is processed to make it representative of a dose received by the user,
this processed measurement is compared with a threshold,
a limitation of activity of the telephone is determined as a function of the result of the comparison.

7. A method according to claim 6, wherein
the energy measured by the telephone during a sliding period is measured.

8. A method according to one of the claims 6 and 7, wherein
the proximity of a user's brain with respect to this telephone is measured.

9. A method according to claim 6, wherein
a value of emitted energy is emitted on the basis of instructed values of power emission dictated by a base station.

10. A method according to one of the claims 6 to 9, wherein
a measurement of the SAR is weighted (C) as a function of the proximity of a user's brain.
